(19) United States
(12) Patent Application Publication
(10) Pub. No.: US 2007/0078545 A1
(43) Pub. Date: Apr. 5, 2007

(54) SOUND OUTPUT SYSTEM AND METHOD

(75) Inventors: Kuan-Hong Hsieh, Shenzhen (CN); Han-Che Wang, Shenzhen (CN); Shin-Hong Chung, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,409

(22) Filed: Aug. 4, 2006

(30) Foreign Application Priority Data
Sep. 23, 2005 (TW) 094133068

(51) Int. Cl. G06F 17/00

(52) U.S. Cl. 700/94

(57) ABSTRACT

A sound output apparatus is provided. The sound output apparatus includes a memory for storing compensation parameters; an analog interface for being connected to an external audio signal generating device; a signal modem for generating a high-frequency compensation parameter signal according to the compensation parameters if the analog interface is connected to the external audio signal generating device; a signal separator for transmitting the high-frequency compensation parameter signal to the external audio signal generating device, and separating regulated audio signals from the external audio signal generating device according to the high-frequency compensation parameter signal, wherein the regulated audio signals are analog audio signals; and a sound output unit for outputting sounds corresponding to the regulated audio signals.

### CROSS-REFERENCES TO RELATED APPLICATION

This application is incorporated with U.S. patent application Ser. No. 11/173130 entitled “sound outputting apparatus having compensation characteristics,” filed on Jul. 1, 2005 herein by reference.

### TECHNICAL FIELD

The present invention relates to sound output systems and methods, and particularly to a sound output system and method having compensation characteristics.

### GENERAL BACKGROUND

Today, we often listen to a portable device, such as an audio signal generating device, via an earphone. For best listening pleasure, users require an earphone that turns audio signals into high fidelity sound.

Human voices and various musical sounds are various signals having complicated waveforms. The frequency of sound audible to the human ear is generally in the range from 20 Hz to 20 KHz. The frequency range of speech is mainly from 150 Hz to 4 KHz, and the frequency range of musical sound is mainly from 40 Hz to 18 KHz. The energy of the human voice is mostly distributed in the frequency range of 200 Hz-35 KHz. Therefore, in order to correctly play such a wide variety of signals and obtain high quality timbre, an earphone is required to have a wide frequency response characteristic, adequate sound pressure levels, and a large dynamic range. Further, an earphone is also desired to attain a perfect frequency-efficiency characteristic and a perfect frequency-phase delay characteristic. If this is achieved, the output of the earphone maintains high power efficiency and low phase leads or delays as compared to the input of the earphone accordingly, a listener will hear sounds in high quality timbre. In the following description, phase leads and phase delays are collectively referred to simply as phase delays.

A conventional earphone typically has a frequency-efficiency characteristic and a frequency-phase delay characteristic. These characteristics typically cause much deviation of the output of the earphone from the input of the earphone. That is, the real output is far from an ideal output, and results in poor timbre.

To solve such problem, what is needed is a sound output system and method which have compensation characteristic.

### SUMMARY

A sound output system is provided. The sound output system includes a sound output apparatus and an audio signal generating device for outputting audio signals. The sound output apparatus includes a memory for storing compensation parameters; an analog interface; wherein the sound output apparatus generates a high-frequency compensation parameter signal according to the compensation parameters if the sound output apparatus is connected to the audio signal generating device, and transmits the high-frequency compensation parameter signal to the audio signal generating device via the analog interface. The audio signal generating device includes an analog interface and a compensation unit; wherein the audio signal generating device receives the high-frequency compensation parameter signal via the analog interface thereof and generates the compensation parameters according to the high-frequency compensation parameter signal, and the compensation unit regulates the audio signals according to the compensation parameters; and a digital/analog (D/A) converter for converting the regulated audio signals into analog audio signals, and transmitting the analog audio signal to the sound output apparatus via the analog interface thereof.

A sound output method is also provided. The sound output method includes the steps of: (a) providing a sound output apparatus and an audio signal generating device for outputting audio signals, the sound output apparatus providing an analog interface; (b) generating a high-frequency compensation parameters signal according to compensation parameters stored in the sound output apparatus if the sound output apparatus is connected to the audio signal generating device, and transmitting the high-frequency compensation parameter signal to the audio signal generating device via the analog interface; (c) generating the compensation parameters according to the high-frequency compensation parameter signal, and regulating the audio signals according to the compensation parameters; (d) converting the regulated audio signals into analog audio signals, and transmitting the analog audio signals to the analog interface of the sound output apparatus; and (e) outputting sounds corresponding to the analog audio signals.

Another sound output apparatus is further provided. The sound output apparatus includes a memory for storing compensation parameters; an analog interface connecting to an external audio signal generating device; a signal modem for generating a high-frequency compensation parameter signal according to the compensation parameters if the analog interface is connected to the external audio signal generating device; a signal separator for transmitting the high-frequency compensation parameter signal to the external audio signal generating device, and separating regulated audio signals from the external audio signal generating device according to the high-frequency compensation parameter signal, wherein the regulated audio signals are analog audio signals; and a sound output unit for outputting sounds corresponding to the regulated audio signals.

Other advantages and novel features will become more apparent from the following detailed description when taken in conjunction with the accompanying drawings, in which:

### BRIEF DESCRIPTION OF DRAWINGS

FIG. 1 is a block diagram of a sound output system in accordance with a preferred embodiment of the present invention; and

FIG. 2 is a flowchart of a preferred sound output method by implementing the system in FIG. 1.

### DETAILED DESCRIPTION OF THE PREFERRED EMBODIMENT

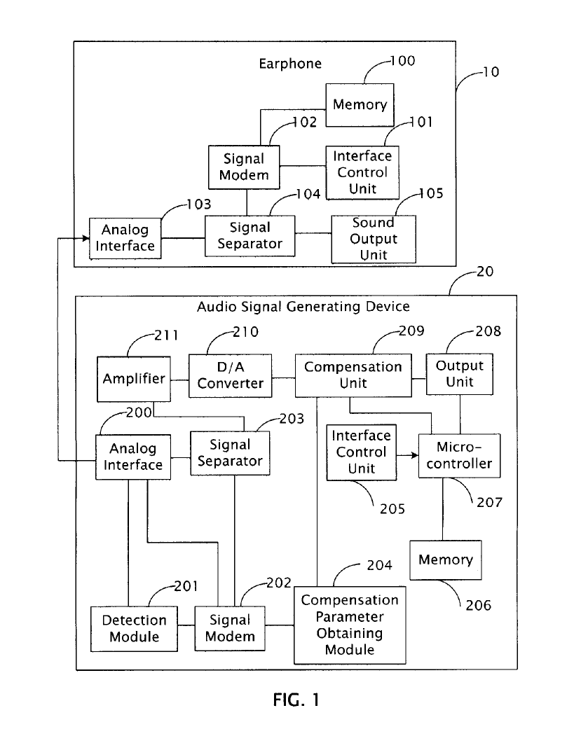

FIG. 1 is a block diagram of a sound output system in accordance with a preferred embodiment of the present invention. The sound output system mainly includes an earphone 10 and an audio signal generating device 20. However, the earphone 10 can be substituted by any other sound output apparatus that can transform audio signals into sounds, such as a speaker or the like. The earphone 10 is used to transform audio signals from a predetermined frequency range into sounds having corresponding sound pressure levels. The audio signal generating device 20 may be an MP3 player, a CD player, a computer, and so on. In the preferred embodiment, the audio signal generating device 20 takes MP3 player as an example.

The earphone 10 includes a memory 100, a signal modem 102, an analog interface 103, a signal separator 104, and a sound output unit 105. The audio signal generating device 20 includes an analog interface 200, a detection module 201, a signal modem 202, a signal separator 203, a compensation parameter obtaining module 204, an interface control unit 205, a memory 206, a micro-controller 207, an output unit 208, a compensation unit 209, a digital/analog (D/A) 210, and an amplifier 211.

The earphone 10 has real characteristics per se, including but not limited to a real frequency-efficiency characteristic and a real frequency-phase delay characteristic. The real characteristics cause real outputs of the earphone 10 to deviate from ideal outputs of the earphone 10, thereby resulting in a distortion of the outputs. In order to prevent the distortion, compensation parameters thereupon are introduced and provided in the memory 100. The compensation parameters include a compensation frequency-efficiency parameter and a compensation frequency-phase delay parameter. Each of the compensation parameters is derived from a testing system (not shown) according to a corresponding real characteristic of the earphone 10, and is adapted to minimize or even eliminate deviations between uncompensated real outputs and ideal outputs of the earphone 10. Building principles of the compensation parameters refer to U.S. patent application Ser. No. 11/173130. In addition, the memory 100 is further connected to the signal modem 102, and the analog interface 103 is connected with the signal separator 104.

The analog interface 200 is connected with the detection module 201, the signal modem 202, and the signal separator 203. The detection module 201 detects whether the analog interface 200 is connected to the earphone 10. If so, the detection module 201 transmits a notification signal to the signal modem 202, the signal modem 202 then converts the notification signal into a high-frequency notification signal, and transmits the high-frequency notification signal to the signal separator 104 of the earphone 10 via the analog interface 200.

The signal separator 104 extracts the high-frequency notification signal received by the analog interface 103, and transmits the high-frequency notification signal to the signal modem 102. The signal modem 102 reads compensation parameters for the earphone 10 stored in memory 100 referencing the high-frequency notification signal, and generates a high-frequency compensation parameter signal according to the compensation parameters. The signal separator 104 further transmits the high-frequency compensation parameter signal to the audio signal generating device 20 via the analog interface 103.

The signal separator 203 extracts the high-frequency compensation parameter signal received by the analog interface 200. The signal modem 202 generates the compensation parameters according to the high-frequency compensation parameter signal. The compensation parameter obtaining module 204 is connected with the signal modem 202 and the compensation unit 209, and is for receiving the compensation parameters. The memory 210 is connected to the micro-controller 207, and is for storing audio files and video files.

If the interface control unit 205 receives a play operation from a user, the micro-controller 207 controls the output unit 208 to read audio files stored in memory 206 and output corresponding audio signals, the compensation unit 209 then regulates the audio signals according to the compensation parameters in order to approach or even attain the ideal output of the earphone 10, and supplies the regulated audio signals to the D/A converter 210 so as to convert the regulated audio signals into analog audio signals. The amplifier 211 amplifies the analog audio signals, and transmits the amplified analog audio signals via the analog interface 200 to the earphone 10. The signal separator 104 extracts the amplified analog audio signals received by the analog interface 103, and supplies the amplified analog audio signals to the sound output unit 105 so as to output corresponding sounds.

The earphone 10 further includes an interface control unit 101. The interface control unit 101 is connected with the signal modem 102, and is used for receiving operational inputs that include adjusting volume and making song selections. The interface control unit 205 is further used for receiving an operational input for adjusting volume.

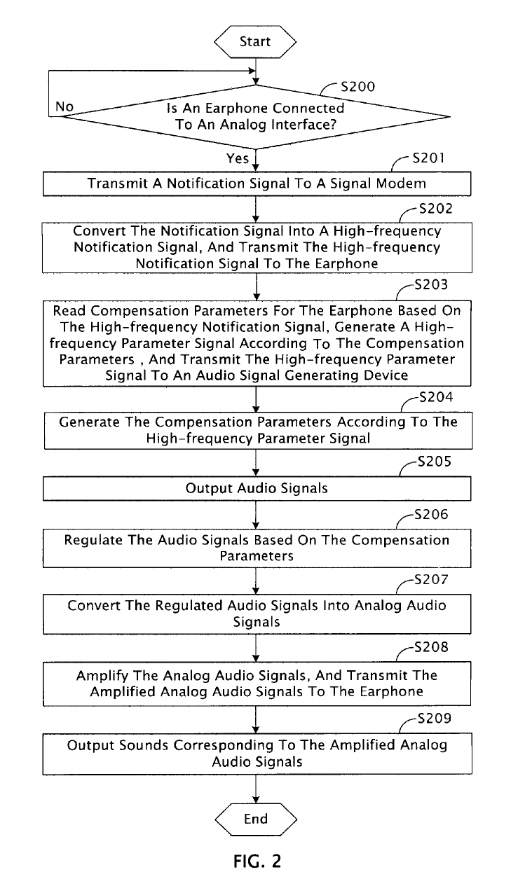

FIG. 2 is a flowchart of a preferred sound output method by implementing the system of FIG. 1. In step S200, the detection module 201 detects whether the analog interface 200 is connected to the earphone 10. If the analog interface 200 is not connected to the earphone 10, the procedure repeats step S200. Otherwise, in step S201, the detection module 201 transmits a notification signal to the signal modem 202. In step S202, the signal modem 202 converts the notification signal into a high-frequency notification signal, and transmits the high-frequency notification signal to the earphone 10 via the analog interface 200.

In step S203, the signal separator 104 extracts the high-frequency notification signal received by the analog interface 103, and transmits the high-frequency notification signal to the signal modem 102, the signal modem 102 reads compensation parameters for the earphone 10 stored in memory 100 referencing the high-frequency notification signal, generates a high-frequency compensation parameter signal according to the compensation parameters, and transmits the high-frequency compensation parameter signal to the audio signal generating device 20 via the analog interface 103.

In step S204, the signal separator 203 extracts the high-frequency compensation parameter signal received by the analog interface 200, the signal modem 202 then generates the compensation parameters according to the high-frequency compensation parameter signal, before the compensation parameter obtaining module 204 receives the compensation parameters.

In step S205, the output unit 208 outputs audio signals. In step S206, the compensation unit 209 regulates the audio signals according to the compensation parameters, in order to approach or even attain the ideal output of the earphone 10. In step S207, the D/A converter 210 converts the regulated audio signals into analog audio signals. In step S208, the amplifier 211 amplifies the analog audio signals, and transmits the amplified analog audio signals to the earphone 10 via the analog interface 200. In step S209, the signal separator 104 extracts the amplified analog audio signals received by the analog interface 103, and transmits the amplified analog audio signals to the sound output unit 105, and the sound output unit 105 outputs sounds corresponding to the amplified analog audio signals.

Although the present invention had been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A sound output system comprising a sound output apparatus and an audio signal generating device for outputting audio signals, wherein:
the sound output apparatus comprises:
a memory for storing compensation parameters; and
an analog interface;
wherein the sound output apparatus generates a high-frequency compensation parameter signal according to the compensation parameters if the sound output apparatus is connected to the audio signal generating device, and transmits the high-frequency compensation parameter signal to the audio signal generating device via the analog interface; and
the audio signal generating device comprises:
an analog interface and a compensation unit;
wherein the audio signal generating device receives the high-frequency compensation parameter signal via the analog interface thereof and generates the compensation parameters according to the high-frequency compensation parameter signal, and the compensation unit regulates the audio signals according to the compensation parameters; and
a digital/analog (D/A) converter for converting the regulated audio signals into analog audio signals, and transmitting the analog audio signal to the sound output apparatus via the analog interface thereof.

2. The sound output system according to claim 1, wherein the compensation parameters are built according to real characteristic for the sound output apparatus.

3. The sound output system according to claim 2, wherein the compensation parameters comprise a compensation frequency-efficiency parameter for minimizing or even eliminating deviations of outputs of the sound output apparatus due to the real characteristics of the sound output apparatus.

4. The sound output system according to claim 2, wherein the compensation parameters comprise a compensation frequency-phase delay parameter respective for minimizing or even eliminating deviations of outputs of the sound output apparatus due to the real characteristics of the sound output apparatus.

5. The sound output system according to claim 1, wherein the sound output apparatus is an earphone.

6. A sound output method providing a sound output apparatus and an audio signal generating device for outputting audio signals, the method comprising the steps of:
providing an analog interface in the sound output apparatus;
generating a high-frequency compensation parameters signal according to compensation parameters stored in the sound output apparatus if the sound output apparatus is connected to the audio signal generating device, and transmitting the high-frequency compensation parameter signal to the audio signal generating device via the analog interface;
generating the compensation parameters according to the high-frequency compensation parameter signal, and regulating the audio signals according to the compensation parameters;
converting the regulated audio signals into analog audio signals, and transmitting the analog audio signals to the analog interface of the sound output apparatus; and
outputting sounds corresponding to the analog audio signals.

7. The sound output method according to claim 6, wherein the compensation parameters comprise a compensation frequency-efficiency parameter for minimizing or even eliminating deviations of outputs of the sound output apparatus due to real characteristics of the sound output apparatus.

8. The sound output method according to claim 6, wherein the compensation parameters comprise a compensation frequency-phase delay parameter for minimizing or even eliminating deviations of outputs of the sound output apparatus due to real characteristics of the sound output apparatus.

9. The sound output method according to claim 6, wherein the sound output apparatus is an earphone.

10. A sound output apparatus comprising:
a memory for storing compensation parameters;
an analog interface connecting to an external audio signal generating device;
a signal modem for generating a high-frequency compensation parameter signal according to the compensation parameters if the analog interface is connected to the external audio signal generating device;
a signal separator for transmitting the high-frequency compensation parameter signal to the external audio signal generating device, and separating regulated audio signals from the external audio signal generating device according to the high-frequency compensation parameter signal, wherein the regulated audio signals are analog audio signals; and
a sound output unit for outputting sounds corresponding to the regulated audio signals.

11. The sound output apparatus 10, wherein the compensation parameters comprise a compensation frequency-efficiency parameter for minimizing or even eliminating deviations of outputs of the sound output apparatus due to real characteristics of the sound output apparatus.

12. The sound output apparatus 10, wherein the compensation parameters comprise a compensation frequency-phase delay parameter for minimizing or even eliminating deviations of outputs of the sound output apparatus due to real characteristics of the sound output apparatus.

13. The sound output apparatus 10, wherein the sound output apparatus is an earphone.
